(19) United States
(12) Patent Application Publication
(10) Pub. No.: US 2025/0090988 A1
(43) Pub. Date: Mar. 20, 2025

(54) FOLDABLE FILTER WITH SUPPORT

(71) Applicant: Jiawei PENG, Yueyang City (CN)

(72) Inventor: Jiawei PENG, Yueyang City (CN)

(73) Assignee: Dongguan Mingen Technology Co., Ltd., Dongguan City (CN)

(21) Appl. No.: 18/963,537

(22) Filed: Nov. 28, 2024

(30) Foreign Application Priority Data
Oct. 17, 2024 (CN) 202422511349.3

(51) Int. Cl. B01D 46/52; B01D 46/00; B01D 46/88

(52) U.S. Cl. CPC B01D 46/521; B01D 46/0005; B01D 46/0016; B01D 46/88; B01D 2201/12

(57) ABSTRACT

A foldable filter with a support includes a filter main body, two end components and a supporting assembly. The filter main body provided with an upper end, a lower end, and a pleated medium extending between the upper end and the lower end. The two end components are respectively connected to the upper end and the lower end of the filter main body, the two end components are adjacent or away from each other. The filter main body switches between a stowed state and an in-use state. An upper end of the supporting assembly is connected to the end component positioned at an upper end, a lower end of the supporting assembly is connected to the end component positioned at a lower end. The supporting assembly limits a distance between the two end components to fix the filter main body in either the stowed state or the in-use state.

### CROSS-REFERENCE TO RELATED APPLICATIONS

The application claims priority of Chinese patent application CN202422511349.3, filed on Oct. 17, 2024, which is incorporated herein by reference in its entireties.

### TECHNICAL FIELD

The present invention relates to the technical field of filtering devices, and in particular, to a foldable filter with a support.

### BACKGROUND OF THE INVENTION

At present, people are attaching increasing importance to the quality of air. In order to breathe high-quality air, people generally use air purifiers and fresh air ventilators to ensure air quality. As an important component in air purifiers and fresh air ventilators, the filtering assembly is directly related to the filtering effect of the products.

In the existing HVAC filters, it is conventional practice to connect the two mounting plates at the upper and lower parts of the foldable filter to the sliding mounting bracket, such as (Aprilaire 213 filter), to form a stable filtering assembly. Then, the sliding mounting bracket is connected to the sliding rail, enabling the filtering assembly to be installed inside the air filter. The sliding mounting bracket can limit the distance between the two mounting plates at the upper and lower parts of the foldable filter, keeping the foldable filter in an unfolded state. With a stable structure, it effectively ensures the stability of the installation structure and further guarantees the filtering effect of the foldable filter. However, when replacing the filter, users are required to detach the foldable filter from the sliding mounting bracket and install a new foldable filter. This involves many operational steps for the users. Moreover, when connecting the two mounting plates at the upper and lower parts of the foldable filter to the sliding mounting bracket, it is easy to scratch the foldable filter main body, which will affect the filtering effect of the product.

Therefore, the present invention provides a foldable filter with a support that can effectively solve the above problems. The foldable filter with a support has a simple structure and stable support. It can be installed in the frame of an air purifier without the need to cooperate with a sliding mounting bracket. The product exhibits excellent stability and good filtering effect.

### SUMMARY OF THE INVENTION

In order to overcome the shortcomings of the prior art, the present invention provides a foldable filter with a support. The foldable filter with a support has a simple structure and stable support. It can be installed in the frame of an air purifier without the need to cooperate with a sliding mounting bracket. The product exhibits excellent stability and good filtering effect.

The technical solution adopted by the present invention to solve the technical problem is as follows.

A foldable filter with a support includes a filter main body, two end components and a supporting assembly.

The filter main body provided with an upper end, a lower end, and a pleated medium extending between the upper end and the lower end.

The two end components are respectively connected to the upper end and the lower end of the filter main body, the two end components are adjacent or away from each other, so that the filter main body switches between a stowed state and an in-use state.

An upper end of the supporting assembly is connected to the end component positioned at an upper end, a lower end of the supporting assembly is connected to the end component positioned at a lower end, and the supporting assembly limits a distance between the two end components to fix the filter main body in either the stowed state or the in-use state.

As an improvement of the present invention, the supporting assembly is provided with a folded-up state and an unfolded state, and switches between the folded-up state and the unfolded state to fix the filter main body in either the stowed state or the in-use state.

As an improvement of the present invention, the supporting assembly includes a first supporting member and a second supporting member, a middle part of the first supporting member is connected to the second supporting member to form the supporting assembly in an “X” shape, a first end of the first supporting member is slidably connected to a left side of the end component positioned at the upper end, a second end of the first supporting member is slidably connected to a right side of the end component positioned at the lower end, a first end of the second supporting member is slidably connected to a right side of the end component positioned at the upper end, and a second end of the second supporting member is slidably connected to a left side of the end component positioned at the lower end.

As an improvement of the present invention, the first end and the second end of the first supporting member and the first end and the second end of the second supporting member are respectively equipped with a sliding block, a strip-shaped sliding groove is respectively arranged on the left side and the right side of the end component, and the sliding block is inserted into the sliding groove and can slide within the sliding groove.

As an improvement of the present invention, the sliding block includes a first abutting portion, a sliding portion and a second abutting portion, an insertion hole is arranged at each end of the first supporting member and the second supporting member, the sliding portion is inserted into the insertion hole and the sliding groove, the first abutting portion abuts against an outer surface of the first supporting member and/or an outer surface of the second supporting member, and the second abutting portion abuts against an inner surface of the end component.

As an improvement of the present invention, a limiting convex block is arranged on an inner wall at an end of the sliding groove, and the limiting convex block is clamped onto a surface of the sliding portion to limit a sliding movement of the sliding portion within the sliding groove.

As an improvement of the present invention, a middle part of the first supporting member is recessed inwards to divide the first supporting member into two end connecting portions and a middle connecting portion, the two end connecting portions are on the same plane, a plane of the middle connecting portion is approximately parallel to the plane of the two end connecting portions, and the middle connecting portion is rotatably connected to the second supporting member through a rotating shaft member.

As an improvement of the present invention, the number of each of the first supporting member and the second supporting member is two, one of the first supporting members and one of the second supporting members are connected to a front side of the end component, and the other first supporting member and the other second supporting member are connected to a rear side of the end component.

As an improvement of the present invention, the supporting assembly includes a third supporting member and a fourth supporting member, a middle part of the third supporting member is connected to the fourth supporting member to form the supporting assembly in an “X” shape, a first end of the third supporting member is connected to the left side of the end component positioned at the upper end, a second end of the third supporting member is connected to the right side of the end component positioned at the lower end, a first end of the fourth supporting member is connected to the right side of the end component positioned at the upper end, and a second end of the fourth supporting member is connected to the left side of the end component positioned at the lower end.

As an improvement of the present invention, the foldable filter with a support further includes a connecting assembly, a first connecting hole is respectively arranged on the first end and the second end of the third supporting member as well as the first end and the second end of the fourth supporting member, a second connecting hole is respectively arranged on the left side and the right side of the end component, and the connecting assembly is inserted into the first connecting hole and the second connecting hole so as to fixedly connect the third supporting member and the fourth supporting member to the end component.

As an improvement of the present invention, the connecting assembly includes a first connecting member and a second connecting member, the first connecting member is equipped with a pressing portion and an insertion rod, the second connecting member is equipped with an abutting portion and an expanding portion, the second connecting member is further equipped with a through hole penetrating through the abutting portion and the expanding portion, the expanding portion is equipped with a slot connecting to the through hole, and the insertion rod is inserted along the through hole and drives the expanding portion to bend and deform outward.

As an improvement of the present invention, an inner wall of a part of the through hole on the expanding portion is arranged in an inclined manner, and a thickness of an upper part of the expanding portion is less than a thickness of a lower part of the expanding portion.

As an improvement of the present invention, the supporting assembly includes a fifth supporting member and a sixth supporting member, an upper end of the fifth supporting member is rotatably connected to the end component positioned at the upper end, a lower end of the sixth supporting member is rotatably connected to the end component positioned at the lower end, and a lower end of the fifth supporting member is rotatably connected to an upper end of the sixth supporting member.

As an improvement of the present invention, one of the fifth supporting member and the sixth supporting member is equipped with a locking slot, the other one of the fifth supporting member and the sixth supporting member is equipped with a locking block, and the locking block is detachably inserted into the locking slot.

As an improvement of the present invention, the foldable filter with a support further includes a connecting shaft, an oblong hole is respectively arranged at the lower end of the fifth supporting member and the upper end of the sixth supporting member, the connecting shaft is rotatably inserted into the two oblong holes and can also translate within the oblong holes, when an extending direction of the fifth supporting member is the same as an extending direction of the sixth supporting member, the fifth supporting member translates towards or away from the sixth supporting member, so that the locking block is inserted into or detached from the locking slot.

As an improvement of the present invention, the number of each of the fifth supporting members and the sixth supporting members is four, two of the fifth supporting members are respectively connected to the left and right ends on a front side of the end component positioned at the upper end, the other two of the fifth supporting members are respectively connected to the left and right ends on a rear side of the end component positioned at the upper end, two of the sixth supporting members are respectively connected to the left and right ends on a front side of the end component positioned at the lower end, the other two of the sixth supporting members are respectively connected to the left and right ends on a rear side of the end component positioned at the lower end, and the fifth supporting members and the sixth supporting members are in one-to-one correspondence.

As an improvement of the present invention, the end component includes a supporting plate and two connecting plates, the two connecting plates are arranged on a front side and a rear side of the support plate and extend towards a position direction of the filter main body, and the connecting plate at least partially shield the filter main body.

As an improvement of the present invention, a sealing projection is arranged on one side of the connecting plate away from the filter main body, the sealing projection extends along a length direction of the connecting plate, and a length of the sealing projection is approximately equal to a length of the connecting plate.

As an improvement of the present invention, the number of the sealing projection is two, and the two sealing projections are spaced apart from each other.

As an improvement of the present invention, the sealing projection, the supporting plate and the connecting plate are integrally formed, and a channel is formed between the sealing projection and the supporting plate.

Beneficial effects: By the arrangement of the above structure, during use, two ends of the supporting assembly are respectively connected to the two end components. The supporting assembly provides a supporting force and limits the relative movement of the two end components to fix the filter main body in the in-use state. Open a filter mounting frame cover, insert a whole filter into a filter mounting frame, and then close the filter mounting frame cover. The filter is stably placed within the filter mounting frame, ensuring the filtering effect of the product. There is no need to use a sliding mounting bracket, which effectively simplifies the operation steps. The installation is simple, facilitating the replacement and maintenance of the filter by users.

### BRIEF DESCRIPTION OF DRAWINGS

In order to explain the technical solutions of the embodiments of the present invention more clearly, the following will briefly introduce the accompanying drawings used in the embodiments. The drawings in the following description are only some embodiments of the present invention. Those of ordinary skill in the art can obtain other drawings based on these drawings without creative work.

The present invention is further described below in detail in combination with the accompanying drawings and embodiments.

FIG. 1 is a schematic structural diagram in an unfolded state according to a first embodiment of the present invention;

FIG. 2 is a schematic structural diagram in a folded-up state according to the first embodiment of the present invention;

FIG. 3 is a partial exploded diagram according to the first embodiment of the present invention;

FIG. 4 is a schematic structural diagram in an unfolded state and when a locking block is inserted into a locking slot according to a second embodiment of the present invention;

FIG. 5 is a schematic structural diagram in the unfolded state and when the locking block is detached from the locking slot according to the second embodiment of the present invention;

FIG. 6 is a schematic structural diagram in a folded-up state according to the second embodiment of the present invention;

FIG. 7 is an enlarged view of circle A of FIG. 4;

FIG. 8 is an enlarged view of circle B of FIG. 5;

FIG. 9 is a schematic structural diagram according to a third embodiment of the present invention;

FIG. 10 is a schematic structural diagram of a connecting assembly in a pre-installation state of the present invention;

FIG. 11 is a schematic structural diagram of the connecting assembly in an installation state of the present invention;

FIG. 12 is an exploded structural diagram of the connecting assembly of the present invention;

FIG. 13 is a cross-sectional view of the connecting assembly in a pre-installation state of the present invention;

FIG. 14 is a cross-sectional view of the connecting assembly in an installation state of the present invention;

FIG. 15 is a schematic diagram of a filter in an installation process of the present invention; and

FIG. 16 is a schematic diagram of the filter in an installation state of the present invention.

### DETAILED DESCRIPTION OF THE INVENTION

To make the aforementioned objectives, features, and advantages of the present invention more comprehensible, specific implementations of the present invention are described in detail below in conjunction with the accompanying drawings. In the following description, numerous specific details are set forth to provide a thorough understanding of the present invention. The present invention may, however, be embodied in many forms different from that described here. A person skilled in the art can make similar improvements without departing from the connotation of the present invention. Therefore, the present invention is not limited by the specific embodiments disclosed below.

In the description of the present invention, It is to be understood that, The terms “center”, “longitudinal”, “transverse”, “upper”, “lower”, “front”, “rear”, “left”, “right”, “vertical”, “horizontal”, “top”, “bottom”, “inner”, “outer”, “clockwise”, “counterclockwise”, and the like indicate azimuth or positional relationships based on the azimuth or positional relationships shown in the drawings, For purposes of convenience only of describing the present invention and simplifying the description, Rather than indicating or implying that the indicated device or element must have a particular orientation, be constructed and operated in a particular orientation, therefore, not to be construed as limiting the present invention.

In addition, the terms “first” and “second” are used for descriptive purposes only, while not to be construed as indicating or implying relative importance or implicitly specifying the number of technical features indicated thereby, features defining “first,” “second,” and “second” may explicitly or implicitly include one or more of the described features. In the description of the present invention, “multiple” means two or more unless explicitly specified otherwise.

In addition, the terms “install”, “arrange”, “provide”, “connect” and “couple” should be understood broadly. For example, it can be a fixed connection, a detachable connection, an integral structure, a mechanical connection, an electrical connection, a direct connection, an indirect connection through an intermediate medium, or a communication between two devices, elements or components. For ordinary technical personnel in this field, the specific meanings of the above terms in present invention can be understood based on specific circumstances.

In the present invention, unless specific regulation and limitation otherwise, the first feature “onto” or “under” the second feature may include the direct contact of the first feature and the second feature, or may include the contact of the first feature and the second feature through other features between them instead of direct contact. Moreover, the first feature “onto”, “above” and “on” the second feature includes that the first feature is right above and obliquely above the second feature, or merely indicates that the horizontal height of the first feature is higher than the second feature. The first feature “under”, “below” and “down” the second feature includes that the first feature is right above and obliquely above the second feature, or merely indicates that the horizontal height of the first feature is less than the second feature.

It should be noted that when an element is referred to as being “fixed to” another element, the element can be directly on another component or there can be a centered element. When an element is considered to be “connected” to another element, the element can be directly connected to another element or there may be a centered element. The terms “inner”, “outer”, “left”, “right”, and similar expressions used herein are for illustrative purposes only and do not necessarily represent the only implementation.

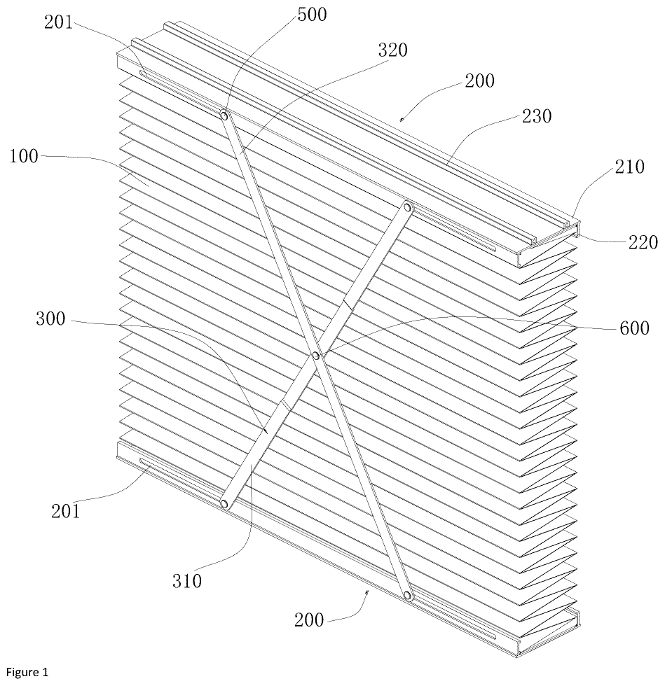

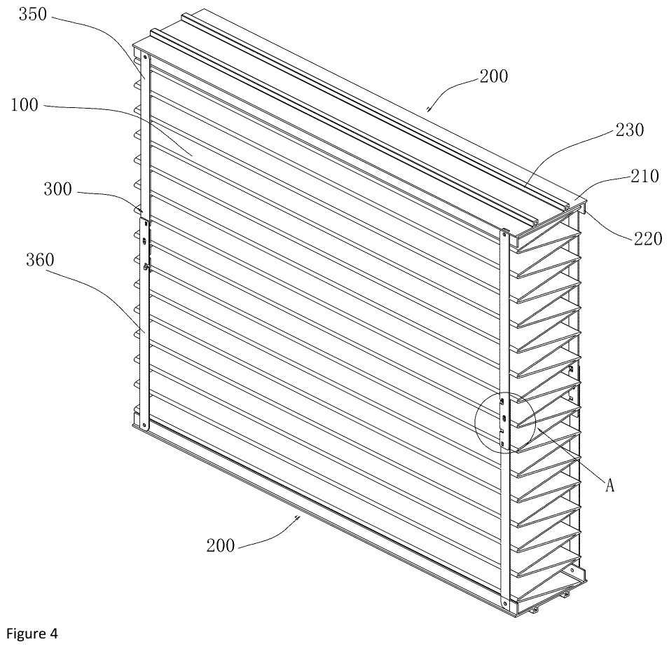

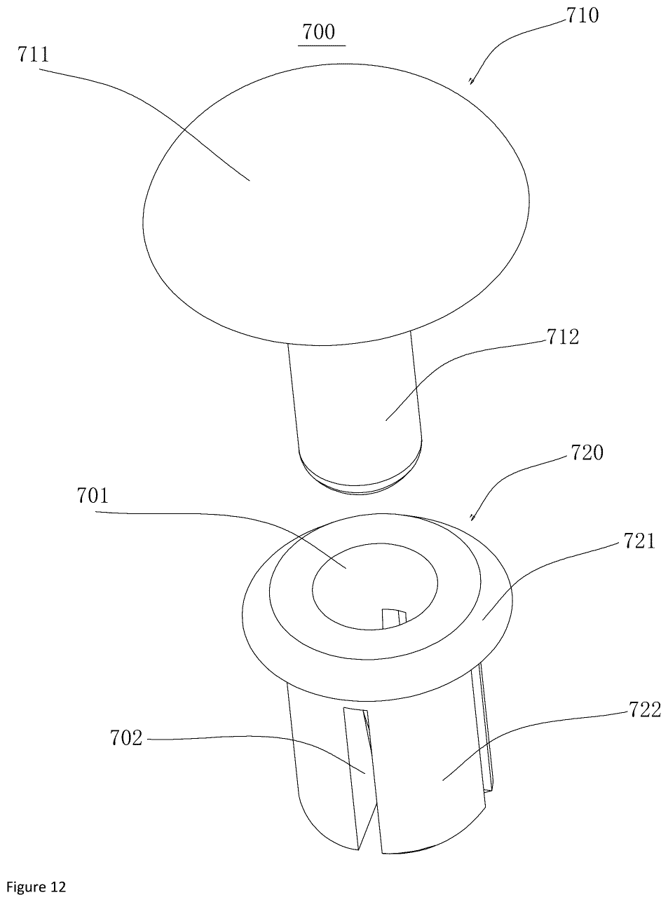

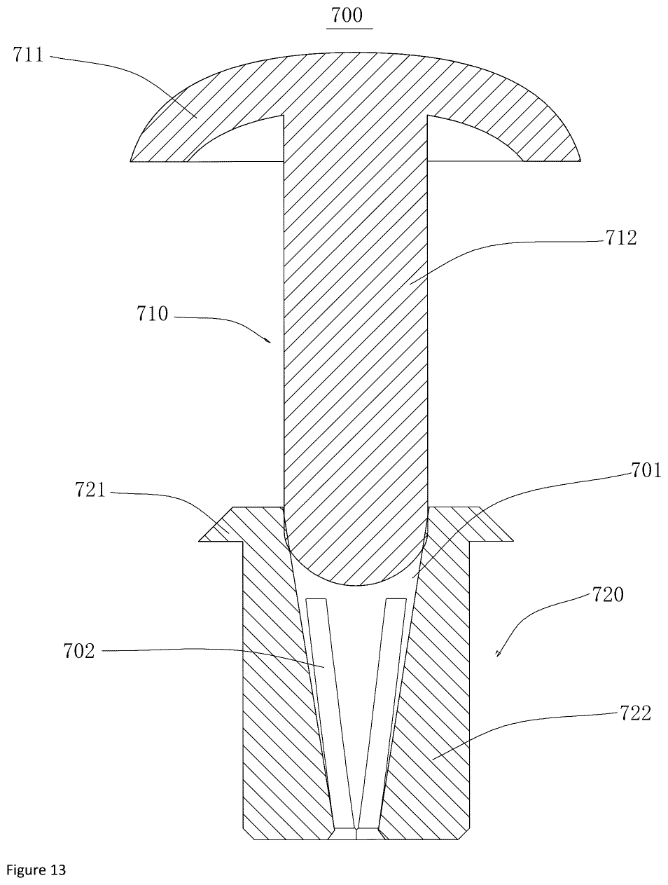

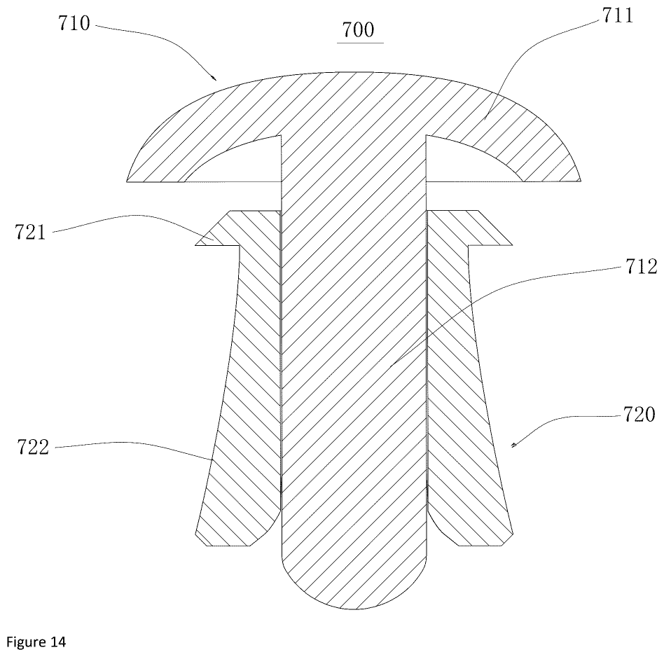

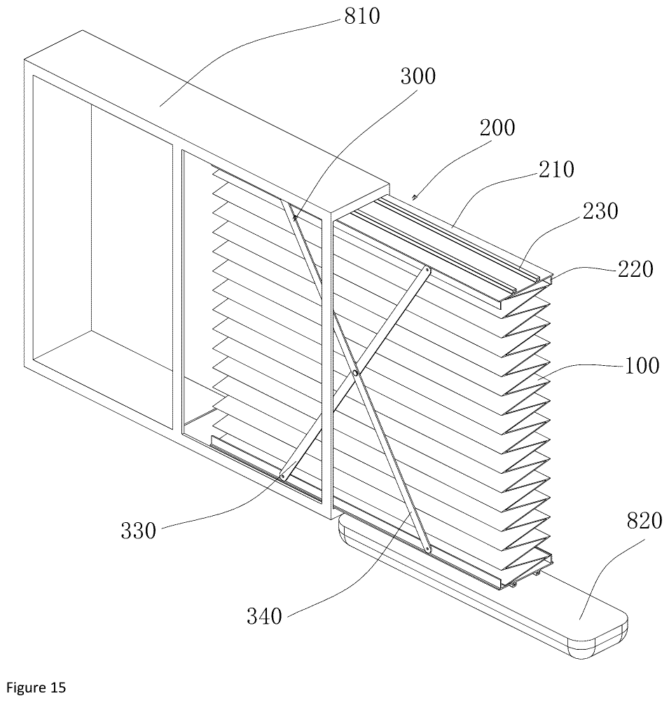

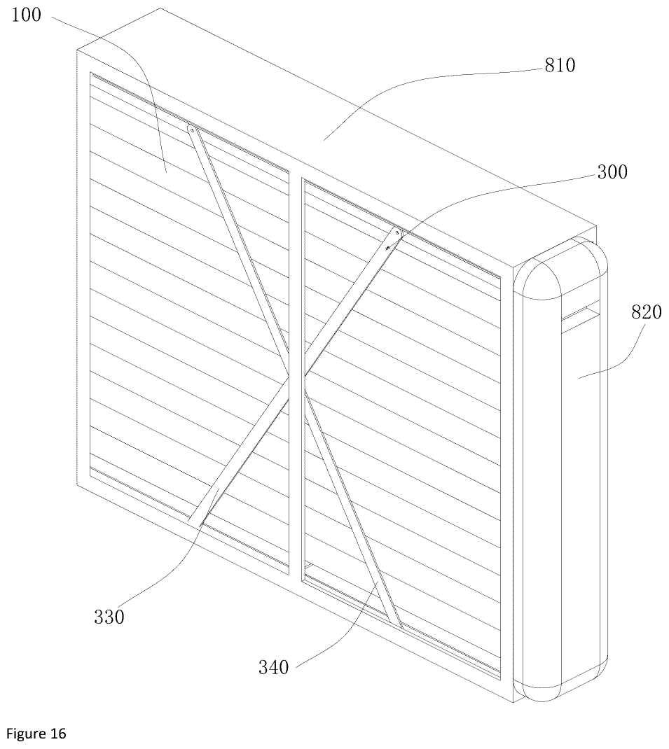

Referring to FIG. 1 to FIG. 16, a foldable filter with a support includes:
a filter main body 100, provided with an upper end, a lower end, and a pleated medium extending between the upper end and the lower end;
two end components 200, specifically, the two end components 200 are respectively connected to the upper end and the lower end of the filter main body 100, the two end components 200 are adjacent or away from each other, so that the filter main body 100 switches between a stowed state and an in-use state;
a supporting assembly 300, specifically, an upper end of the supporting assembly 300 is connected to the end component 200 positioned at an upper end, a lower end of the supporting assembly 300 is connected to the end component 200 positioned at a lower end, and the supporting assembly 300 limits a distance between the two end components 200 to fix the filter main body 100 in either the stowed state or the in-use state.

By the arrangement of the above structure, during use, two ends of the supporting assembly 300 are respectively connected to the two end components 200. The supporting assembly 300 provides a supporting force and limits the relative movement of the two end components 200 to fix the filter main body 100 in the in-use state. Open a filter mounting frame cover 820, insert a whole filter into a filter mounting frame 810, and then close the filter mounting frame cover 820. The filter is stably placed within the filter mounting frame 810, ensuring the filtering effect of the product. There is no need to use a sliding mounting bracket, which effectively simplifies the operation steps. The installation is simple, facilitating the replacement and maintenance of the filter by users.

In this embodiment, the supporting assembly 300 is provided with a folded-up state and an unfolded state, and switches between the folded-up state and the unfolded state to fix the filter main body 100 in either the stowed state or the in-use state. By the arrangement of the above structure, when using the filter, adjust the supporting assembly 300 to the unfolded state. The supporting assembly 300 will fix the filter main body 100 in the in-use state, enlarging the area of the filter and effectively ensuring the filtering effect. Meanwhile, when storing or transporting the filter, adjust the supporting assembly 300 to the folded-up state, reducing the volume of the filter main body and facilitating users to store and transport the filter.

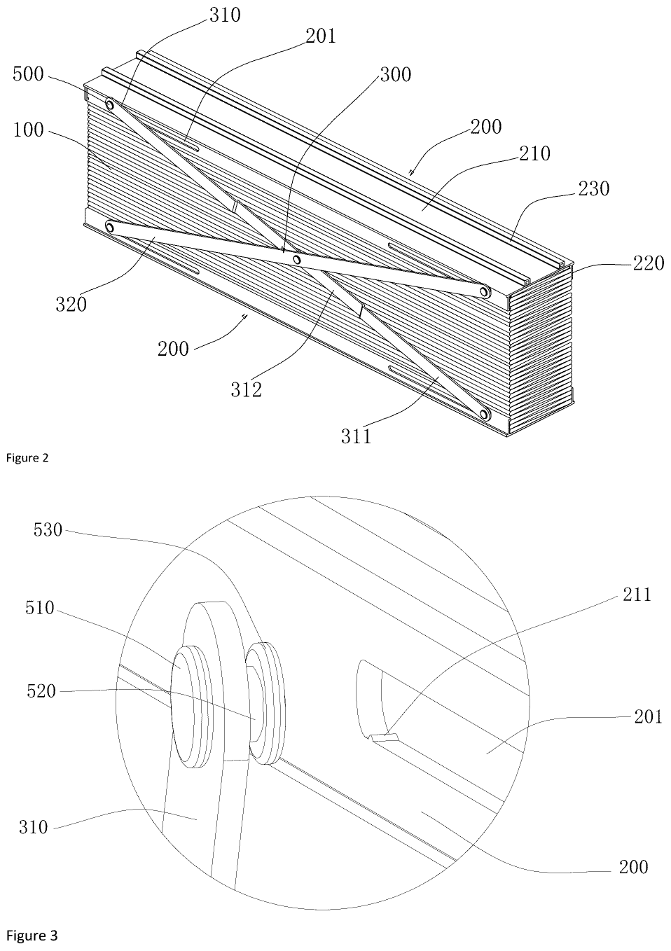

In this embodiment, the supporting assembly 300 includes a first supporting member 310 and a second supporting member 320, a middle part of the first supporting member 310 is connected to the second supporting member 320 to form the supporting assembly 300 in an “X” shape, a first end of the first supporting member 310 is slidably connected to a left side of the end component 200 positioned at the upper end, a second end of the first supporting member 310 is slidably connected to a right side of the end component 200 positioned at the lower end, a first end of the second supporting member 320 is slidably connected to a right side of the end component 200 positioned at the upper end, and a second end of the second supporting member 320 is slidably connected to a left side of the end component 200 positioned at the lower end. By the arrangement of the above structure, referring to FIG. 1 to FIG. 2, during use, slide the ends of the first supporting member 310 and the second supporting member 320 along the end component 200. Meanwhile, rotate the first supporting member 310 relative to the second supporting member 320 to adjust the height of the supporting assembly 300. Consequently, the filter main body 100 can be switched between the stowed state and the in-use state, which facilitates users to use or store the filter.

In this embodiment, the first end and the second end of the first supporting member 310 and the first end and the second end of the second supporting member 320 are respectively equipped with a sliding block 500, a strip-shaped sliding groove 201 is respectively arranged on the left side and the right side of the end component 200, and the sliding block 500 is inserted into the sliding groove 201 and can slide within the sliding groove 201. By the arrangement of the above structure, when storing the filter, slide the sliding block 500 to the outermost side of the sliding groove 201. At this time, the height of the supporting assembly 300 is minimized, keeping the filter main body 100 in the folded stowed state with its volume reduced, which facilitates users to store and stow the filter. When using the filter, slide the sliding block 500 to the innermost side of the sliding groove 201. Then the height of the supporting assembly 300 is maximized, effectively unfolding the filter main body 100 and switching it to the in-use state, making it convenient for users to insert the filter into the filter mounting frame 810. The installation is simple and the filtering effect is good.

In this embodiment, the sliding block 500 includes a first abutting portion 510, a sliding portion 520 and a second abutting portion 530, an insertion hole is arranged at each end of the first supporting member 310 and the second supporting member 320, the sliding portion 520 is inserted into the insertion hole and the sliding groove 201, the first abutting portion 510 abuts against an outer surface of the first supporting member 310 and/or an outer surface of the second supporting member 320, and the second abutting portion 530 abuts against an inner surface of the end component 200. By the arrangement of the above structure, referring to FIG. 3, the first abutting portion 510 and the second abutting portion 530 can effectively limit the movement of the sliding portion 520, preventing the sliding portion 520 from disengaging from the sliding groove 201, thus ensuring the stability of the product and prolonging its service life.

In this embodiment, a limiting convex block 211 is arranged on an inner wall at an end of the sliding groove 201, and the limiting convex block 211 is clamped onto a surface of the sliding portion 520 to limit a sliding movement of the sliding portion 520 within the sliding groove 201. By the arrangement of the above structure, when using the filter, slide the sliding block 500 to the innermost side of the sliding groove 201. The limiting convex block 211 will be clamped onto the surfaces of the sliding portion 520, hindering the sliding of the sliding block 500 within the sliding groove 201, thus keeping the supporting assembly 300 in the unfolded state, effectively fixing the shape of the filter main body 100, facilitating users to use the filter and making the product structure more stable.

In this embodiment, a middle part of the first supporting member 310 is recessed inwards to divide the first supporting member 310 into two end connecting portions 311 and a middle connecting portion 312, the two end connecting portions 311 are on the same plane, a plane of the middle connecting portion 312 is approximately parallel to the plane of the two end connecting portions 311, and the middle connecting portion 312 is rotatably connected to the second supporting member 320 through a rotating shaft member 600. By the arrangement of the above structure, the middle part of the first supporting member 310 is rotatably connected to the middle part of the second supporting member 320. The middle connecting portion 312 is recessed inwards, making the end connecting portions 311 and the second supporting member 320 be on the same plane. This facilitates users to install the first supporting member 310 and the second supporting member 320 onto the end component 200, avoiding the existence of an installation gap between the second supporting member 320 and the end component 200 due to the thickness of the first supporting member 310, and thus improving the installation stability of the product.

In this embodiment, the number of each of the first supporting member 310 and the second supporting member 320 is two, one of the first supporting members 310 and one of the second supporting members 320 are connected to a front side of the end component 200, and the other first supporting member 310 and the other second supporting member 320 are connected to a rear side of the end component 200. By the arrangement of the above structure, the first supporting members 310 and the second supporting members 320 are arranged on the front side and the rear side of the filter main body 100, which can balance the forces on the filter main body 100 and the end component 200, further ensuring the stability of the product.

In this embodiment, the supporting assembly 300 includes a third supporting member 330 and a fourth supporting member 340, a middle part of the third supporting member 330 is connected to the fourth supporting member 340 to form the supporting assembly 300 in an “X” shape, a first end of the third supporting member 330 is connected to the left side of the end component 200 positioned at the upper end, a second end of the third supporting member 330 is connected to the right side of the end component 200 positioned at the lower end, a first end of the fourth supporting member 340 is connected to the right side of the end component 200 positioned at the upper end, and a second end of the fourth supporting member 340 is connected to the left side of the end component 200 positioned at the lower end. By the arrangement of the above structure, referring to FIG. 9, when using the filter, connect the third supporting member 330 and the fourth supporting member 340 to the end component 200. The third supporting member 330 and the fourth supporting member 340 will support the two end components 200, fixing the filter main body 100 in the in-use state and ensuring the filtering effect of the product. When storing the filter, detach the third supporting member 330 and the fourth supporting member 340 from the end component 200. Then move the two end components 200 towards each other to reduce the volume of the filter main body 100, facilitating users to store the product.

In this embodiment, the foldable filter with a support further includes a connecting assembly 700, a first connecting hole 302 is respectively arranged on the first end and the second end of the third supporting member 330 as well as the first end and the second end of the fourth supporting member 340, a second connecting hole is respectively arranged on the left side and the right side of the end component 200, and the connecting assembly 700 is inserted into the first connecting hole 302 and the second connecting hole so as to fixedly connect the third supporting member 330 and the fourth supporting member 340 to the end component 200. By the arrangement of the above structure, the connecting assembly 700 enables a more convenient connection between the third supporting member 330 and the fourth supporting member 340 and the end component 200, providing ease of use.

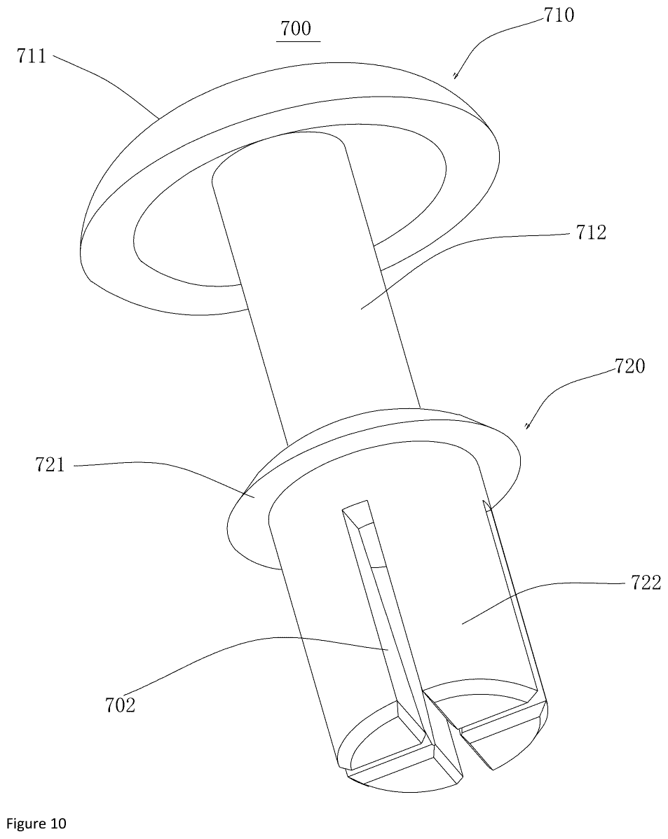

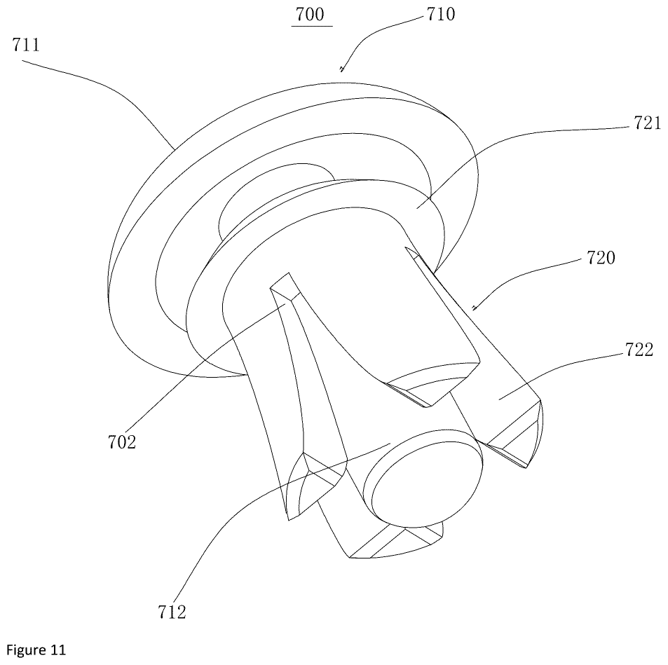

In this embodiment, the connecting assembly 700 includes a first connecting member 710 and a second connecting member 720, the first connecting member 710 is equipped with a pressing portion 711 and an insertion rod 712, the second connecting member 720 is equipped with an abutting portion 721 and an expanding portion 722, the second connecting member 720 is further equipped with a through hole 701 penetrating through the abutting portion 721 and the expanding portion 722, the expanding portion 722 is equipped with a slot 702 connecting to the through hole 701, and the insertion rod 712 is inserted along the through hole 701 and drives the expanding portion 722 to bend and deform outward. By the arrangement of the above structure, referring to FIG. 10 to FIG. 14, during use, align the first connecting hole 302 with the second connecting hole. Insert the insertion rod 712 until it reaches an end of the through hole 701. The expanding portion 722 passes through the first connecting hole 302 and the second connecting hole, and then abuts the abutting portion 721 against an edge of the first connecting hole 302. Press the pressing portion 711 firmly. The insertion rod 712 will be fully inserted into the through hole 701, squeezing an inner wall of the through hole 701. This causes one side of the expanding portion 722 away from the abutting portion 721 to expand outward, enabling the connecting assembly 700 to connect the third supporting member 330 and the fourth supporting member 340 to the end component 200. It is convenient to use and the connection is stable.

In this embodiment, an inner wall of a part of the through hole 701 on the expanding portion 722 is arranged in an inclined manner, and a thickness of an upper part of the expanding portion 722 is less than a thickness of a lower part of the expanding portion 722. By the arrangement of the above structure, the inner wall of the through hole 701 is arranged in an inclined manner. When the insertion rod 712 is gradually inserted along the through hole 701, it gradually squeezes the inner wall of the through hole 701, causing the side of the expanding portion 722 away from the abutting portion 721 to expand outward. This enables the connecting assembly 700 to connect the third supporting member 330 and the fourth supporting member 340 to the end component 200, providing convenience in use and stable connection.

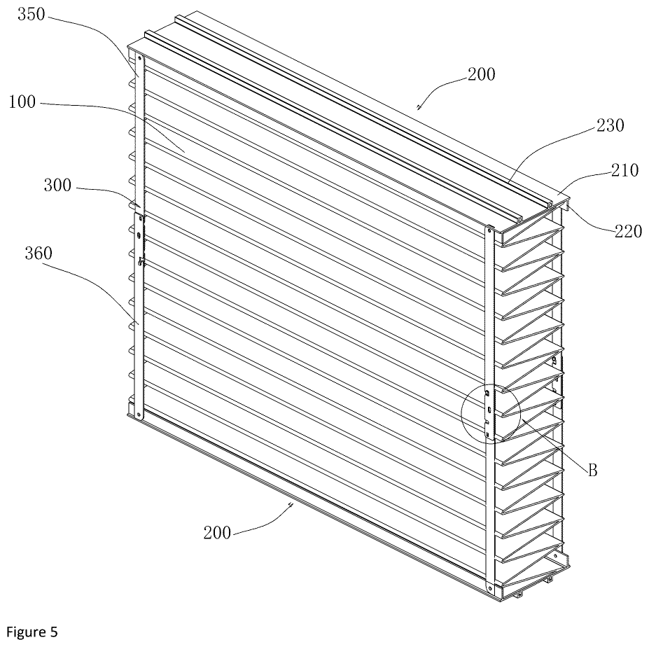

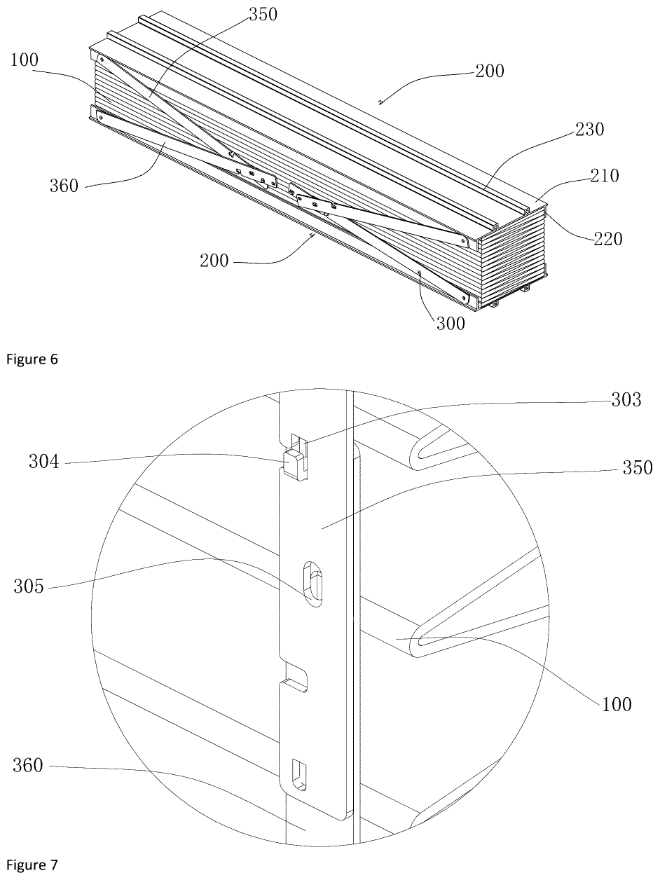

In this embodiment, the supporting assembly 300 includes a fifth supporting member 350 and a sixth supporting member 360, an upper end of the fifth supporting member 350 is rotatably connected to the end component 200 positioned at the upper end, a lower end of the sixth supporting member 360 is rotatably connected to the end component 200 positioned at the lower end, and a lower end of the fifth supporting member 350 is rotatably connected to an upper end of the sixth supporting member 360. By the arrangement of the above structure, referring to FIG. 6, rotate the fifth supporting member 350 and the sixth supporting member 360 to gradually fold the supporting assembly 300, reducing the distance between the two end components 200 and making the volume of the filter main body 100 smaller, thus facilitating users to store the product. When using the filter, referring to FIG. 5, rotate the fifth supporting member 350 and the sixth supporting member 360 to the unfolded state, effectively expanding the filter main body 100, facilitating users to install it and ensuring the filtering effect.

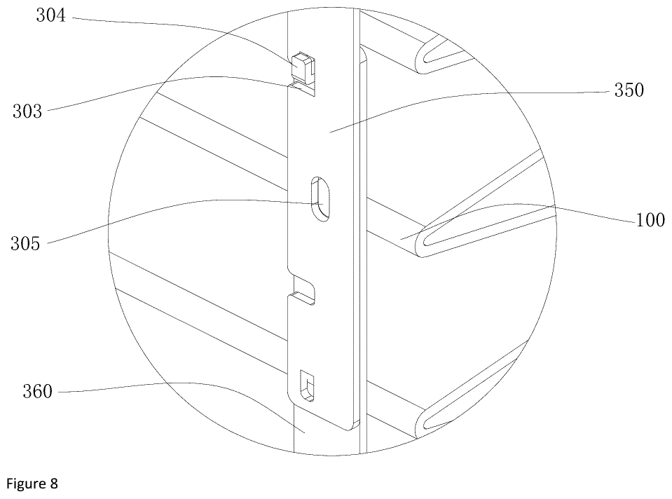

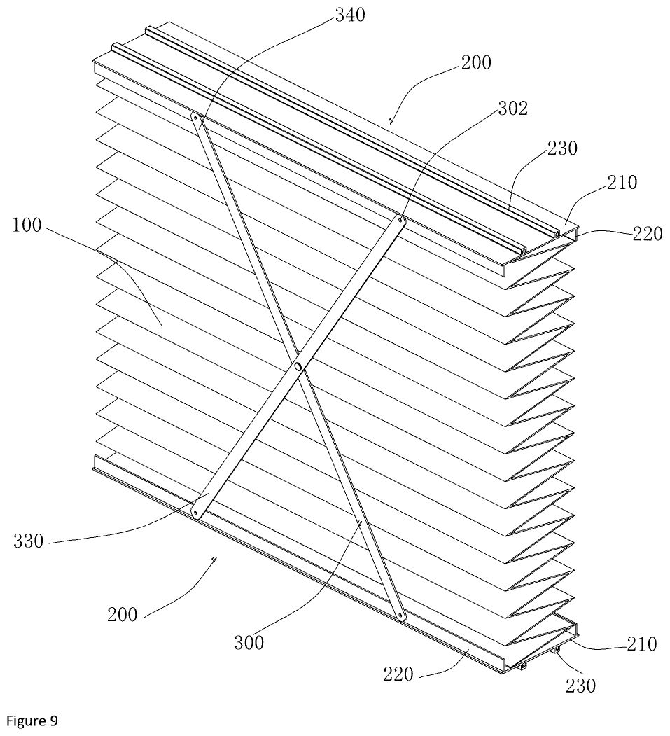

In this embodiment, one of the fifth supporting member 350 and the sixth supporting member 360 is equipped with a locking slot 303, the other one of the fifth supporting member 350 and the sixth supporting member 360 is equipped with a locking block 304, and the locking block 304 is detachably inserted into the locking slot 303. By the arrangement of the above structure, referring to FIG. 7 and FIG. 8, when using the filter, insert the locking block 304 into the locking slot 303 to fix the fifth supporting member 350 and the sixth supporting member 360, limiting the rotation between the fifth supporting member 350 and the sixth supporting member 360. Consequently, the filter main body 100 is fixed in the in-use state, facilitating users to use the filter.

In this embodiment, the foldable filter with a support further includes a connecting shaft, an oblong hole 305 is respectively arranged at the lower end of the fifth supporting member 350 and the upper end of the sixth supporting member 360, the connecting shaft is rotatably inserted into the two oblong holes 350 and can also translate within the oblong holes 350, when an extending direction of the fifth supporting member 350 is the same as an extending direction of the sixth supporting member 360, the fifth supporting member 350 translates towards or away from the sixth supporting member 360, so that the locking block 304 is inserted into or detached from the locking slot 303. By the arrangement of the above structure, during use, move the fifth supporting member 350 away from the sixth supporting member 360 to detach the locking block 304 from the locking slot 303, facilitating users to rotate the fifth supporting member 350 and the sixth supporting member 360, thereby adjusting the configuration of the supporting assembly 300. When it is necessary to fix and support the filter main body 100, move the fifth supporting member 350 towards the sixth supporting member 360 to insert the locking block 304 into the locking slot 303, thus fixing the fifth supporting member 350 and the sixth supporting member 360 and enabling the supporting assembly 300 to effectively fix the filter main body 100, making it convenient to use the product.

In this embodiment, the number of each of the fifth supporting members 350 and the sixth supporting members 360 is four, two of the fifth supporting members 350 are respectively connected to the left and right ends on a front side of the end component 200 positioned at the upper end, the other two of the fifth supporting members 350 are respectively connected to the left and right ends on a rear side of the end component positioned at the upper end, two of the sixth supporting members 360 are respectively connected to the left and right ends on a front side of the end component 200 positioned at the lower end, the other two of the sixth supporting members 360 are respectively connected to the left and right ends on a rear side of the end component positioned at the lower end, and the fifth supporting members 350 and the sixth supporting members 360 are in one-to-one correspondence. By the arrangement of the above structure, the four fifth supporting members 350 and the four sixth supporting members 360 form four supporting assemblies 300, which respectively support at the two ends on the front side and the two ends on the rear side of the end component 200. This enables the end component 200 to be stably stressed, thereby ensuring the stability of the product, facilitating users to use the product and guaranteeing the filtering effect of the product.

In this embodiment, the end component 300 includes a supporting plate 220 and two connecting plates 210, the two connecting plates 210 are arranged on a front side and a rear side of the support plate 220 and extend towards a position direction of the filter main body 100, and the connecting plate 210 at least partially shield the filter main body 100. By the arrangement of the above structure, the supporting plate 220 can protect an upper surface and a lower surface of the filter main body 100 and also provide supporting force, facilitating users to pick up and install the filter. The connecting plate 210 can smooth an edge of the supporting plate 220 and increase a surface area of the edge of the supporting plate 220, making it convenient for users to pick up the product. Meanwhile, the connecting plate 210 can protect an upper edge and a lower edge of the filter main body 100. When users insert the filter into the filter device, the connecting plates 210 can protect the filter main body 100 from being scratched, ensuring the filtering effect of the product.

In this embodiment, a sealing projection 230 is arranged on one side of the connecting plate 210 away from the filter main body 100, the sealing projection 230 extends along a length direction of the connecting plate 210, and a length of the sealing projection 230 is approximately equal to a length of the connecting plate 210. By the arrangement of the above structure, during use, insert the entire filter into the air filter. An outer surface of the sealing projection 230 abuts against an inner surface of a cavity of the air filter, preventing an airflow from flowing along an edge of the filter product and ensuring the filtering effect of the product.

In this embodiment, the number of the sealing projection 230 is two, and the two sealing projections 230 are spaced apart from each other. By the arrangement of the above structure, the two sealing projections 230 that are spaced apart from each other can effectively support the end component 200, preventing the product from tipping over. Moreover, the two sealing projections 230 can further ensure the sealing effect, enabling the filter to be stably connected to the filter in a sealed manner.

In this embodiment, the sealing projection 230, the supporting plate 220 and the connecting plate 210 are integrally formed, and a channel is formed between the sealing projection 230 and the supporting plate 220. By the arrangement of the above structure, the sealing projection 230, the supporting plate 220 and the connecting plate 210 are integrally formed, which can prevent the airflow from flowing through the gaps among them, ensuring the airtightness of the product. Consequently, the airflow can only pass through the filter main body 100, guaranteeing the filtering effect. Moreover, the production efficiency is also higher.

1. A foldable filter with a support, comprising:
a filter main body, provided with an upper end, a lower end, and a pleated medium extending between the upper end and the lower end;
two end components, wherein the two end components are respectively connected to the upper end and the lower end of the filter main body, the two end components are adjacent or away from each other, so that the filter main body switches between a stowed state and an in-use state;
a supporting assembly, wherein an upper end of the supporting assembly is connected to the end component positioned at an upper end, a lower end of the supporting assembly is connected to the end component positioned at a lower end, and the supporting assembly limits a distance between the two end components to fix the filter main body in either the stowed state or the in-use state.

2. The foldable filter with a support according to claim 1, wherein the supporting assembly is provided with a folded-up state and an unfolded state, and switches between the folded-up state and the unfolded state to fix the filter main body in either the stowed state or the in-use state.

3. The foldable filter with a support according to claim 2, wherein the supporting assembly comprises a first supporting member and a second supporting member, a middle part of the first supporting member is connected to the second supporting member to form the supporting assembly in an “X” shape, a first end of the first supporting member is slidably connected to a left side of the end component positioned at the upper end, a second end of the first supporting member is slidably connected to a right side of the end component positioned at the lower end, a first end of the second supporting member is slidably connected to a right side of the end component positioned at the upper end, and a second end of the second supporting member is slidably connected to a left side of the end component positioned at the lower end.

4. The foldable filter with a support according to claim 3, wherein the first end and the second end of the first supporting member and the first end and the second end of the second supporting member are respectively equipped with a sliding block, a strip-shaped sliding groove is respectively arranged on the left side and the right side of the end component, and the sliding block is inserted into the sliding groove and can slide within the sliding groove.

5. The foldable filter with a support according to claim 4, wherein the sliding block comprises a first abutting portion, a sliding portion and a second abutting portion, an insertion hole is arranged at each end of the first supporting member and the second supporting member, the sliding portion is inserted into the insertion hole and the sliding groove, the first abutting portion abuts against an outer surface of the first supporting member and/or an outer surface of the second supporting member, and the second abutting portion abuts against an inner surface of the end component.

6. The foldable filter with a support according to claim 5, wherein a limiting convex block is arranged on an inner wall at an end of the sliding groove, and the limiting convex block is clamped onto a surface of the sliding portion to limit a sliding movement of the sliding portion within the sliding groove.

7. The foldable filter with a support according to claim 3, wherein a middle part of the first supporting member is recessed inwards to divide the first supporting member into two end connecting portions and a middle connecting portion, the two end connecting portions are on the same plane, a plane of the middle connecting portion is approximately parallel to the plane of the two end connecting portions, and the middle connecting portion is rotatably connected to the second supporting member through a rotating shaft member.

8. The foldable filter with a support according to claim 3, wherein the number of each of the first supporting member and the second supporting member is two, one of the first supporting members and one of the second supporting members are connected to a front side of the end component, and the other first supporting member and the other second supporting member are connected to a rear side of the end component.

9. The foldable filter with a support according to claim 1, wherein the supporting assembly comprises a third supporting member and a fourth supporting member, a middle part of the third supporting member is connected to the fourth supporting member to form the supporting assembly in an “X” shape, a first end of the third supporting member is connected to the left side of the end component positioned at the upper end, a second end of the third supporting member is connected to the right side of the end component positioned at the lower end, a first end of the fourth supporting member is connected to the right side of the end component positioned at the upper end, and a second end of the fourth supporting member is connected to the left side of the end component positioned at the lower end.

10. The foldable filter with a support according to claim 9, further comprising a connecting assembly, wherein a first connecting hole is respectively arranged on the first end and the second end of the third supporting member as well as the first end and the second end of the fourth supporting member, a second connecting hole is respectively arranged on the left side and the right side of the end component, and the connecting assembly is inserted into the first connecting hole and the second connecting hole so as to fixedly connect the third supporting member and the fourth supporting member to the end component.

11. The foldable filter with a support according to claim 10, wherein the connecting assembly comprises a first connecting member and a second connecting member, the first connecting member is equipped with a pressing portion and an insertion rod, the second connecting member is equipped with an abutting portion and an expanding portion, the second connecting member is further equipped with a through hole penetrating through the abutting portion and the expanding portion, the expanding portion is equipped with a slot connecting to the through hole, and the insertion rod is inserted along the through hole and drives the expanding portion to bend and deform outward.

12. The foldable filter with a support according to claim 11, wherein an inner wall of a part of the through hole on the expanding portion is arranged in an inclined manner, and a thickness of an upper part of the expanding portion is less than a thickness of a lower part of the expanding portion.

13. The foldable filter with a support according to claim 2, wherein the supporting assembly comprises a fifth supporting member and a sixth supporting member, an upper end of the fifth supporting member is rotatably connected to the end component positioned at the upper end, a lower end of the sixth supporting member is rotatably connected to the end component positioned at the lower end, and a lower end of the fifth supporting member is rotatably connected to an upper end of the sixth supporting member.

14. The foldable filter with a support according to claim 13, wherein one of the fifth supporting member and the sixth supporting member is equipped with a locking slot, the other one of the fifth supporting member and the sixth supporting member is equipped with a locking block, and the locking block is detachably inserted into the locking slot.

15. The foldable filter with a support according to claim 14, further comprising a connecting shaft, wherein an oblong hole is respectively arranged at the lower end of the fifth supporting member and the upper end of the sixth supporting member, the connecting shaft is rotatably inserted into the two oblong holes and can also translate within the oblong holes, when an extending direction of the fifth supporting member is the same as an extending direction of the sixth supporting member, the fifth supporting member translates towards or away from the sixth supporting member, so that the locking block is inserted into or detached from the locking slot.

16. The foldable filter with a support according to claim 14, wherein the number of each of the fifth supporting members and the sixth supporting members is four, two of the fifth supporting members are respectively connected to the left and right ends on a front side of the end component positioned at the upper end, the other two of the fifth supporting members are respectively connected to the left and right ends on a rear side of the end component positioned at the upper end, two of the sixth supporting members are respectively connected to the left and right ends on a front side of the end component positioned at the lower end, the other two of the sixth supporting members are respectively connected to the left and right ends on a rear side of the end component positioned at the lower end, and the fifth supporting members and the sixth supporting members are in one-to-one correspondence.

17. The foldable filter with a support according to claim 1, wherein the end component comprises a supporting plate and two connecting plates, the two connecting plates are arranged on a front side and a rear side of the support plate and extend towards a position direction of the filter main body, and the connecting plate at least partially shield the filter main body.

18. The foldable filter with a support according to claim 17, wherein a sealing projection is arranged on one side of the connecting plate away from the filter main body, the sealing projection extends along a length direction of the connecting plate, and a length of the sealing projection is approximately equal to a length of the connecting plate.

19. The foldable filter with a support according to claim 18, wherein the number of the sealing projection is two, and the two sealing projections are spaced apart from each other.

20. The foldable filter with a support according to claim 18, wherein the sealing projection, the supporting plate and the connecting plate are integrally formed, and a channel is formed between the sealing projection and the supporting plate.
